(19) United States
(12) Patent Application Publication
(10) Pub. No.: US 2026/0214395 A1
(43) Pub. Date: Jul. 23, 2026

(54) METHOD FOR DETERMINING PERSONALIZED TRAINING DATA FOR A USER OF A HEARING AID

(71) Applicant: Oticon A/S, Smørum (DK)

(72) Inventors: Peter Asbjørn Leer BYSTED, Smørum (DK); Svend FELDT, Smørum (DK); Jesper JENSEN, Smørum (DK)

(21) Appl. No.: 19/414,327

(22) Filed: Dec. 10, 2025

(30) Foreign Application Priority Data
Jan. 17, 2025 (EP) 25152430.2

(51) Int. Cl. H04R 25/00; G10L 25/84

(52) U.S. Cl. CPC H04R 25/507; G10L 25/84; H04R 25/30; H04R 25/453; H04R 2225/41; H04R 2225/43

(57) ABSTRACT

Disclosed herein are embodiments of a method for determining personalized training data. The method includes obtaining a set of in-situ input signals, determining a set of in-situ voice signals and a set of in-situ-noise signals, obtaining a set of generic noise signals, obtaining a set of generic clean speech signals, and determining a personalized training data set.

### CROSS REFERENCE TO RELATED APPLICATIONS

Any and all applications for which a foreign or domestic priority claim is identified in the Application Data Sheet as filed with the present application are hereby incorporated by reference under 37 CFR 1.57.

### TECHNICAL FIELD

The present application relates to the field of noise reduction for hearing aids. The present application relates to methods for training deep neural network for noise reduction for hearing aids. The present application relates to methods for collecting personalized training data from real-world usage of the hearing aid for training deep neural networks.

### SUMMARY

In an aspect of the present application, a method for determining personalized training data for a user of a hearing aid is provided. The method comprises obtaining a set of in-situ input signals obtained by the hearing aid. The method comprises determining a set of in-situ voice signals based on the set of in-situ input signals. The method comprises determining a set of in-situ-noise signals based on the set of in-situ input signals. The method comprises obtaining a set of generic noise signals. The method comprises obtaining a set of generic clean speech signals. The method comprises determining a personalized training data set based on the set of in-situ voice signals. The method comprises determining a personalized training data set based on the set of in-situ-noise signals. The method comprises determining a personalized training data set based on the set of generic noise signals. The method comprises determining a personalized training data set based on the set of generic clean speech signals.

Thus, an easily implemented method for providing a user personalized training data set is provided. By providing a user personalized training data set the hearing aid may be better adapted to fit the needs of the user of the hearing aid.

A hearing aid may be configured to pick-up sound by an input transducer of the hearing aid. The picked-up sound may be the sound of an environment the user is located in while wearing the hearing aid. The sound of the environment may comprise a desired voice signal and a noise signal. The desired voice signal may be a voice signal i.e., a speech signal). The noise signal may be an undesired ambient sound such as reverberation, car noise, machine noise, microphone self-noise (i.e., noise being generated internally by the microphone or other analog electronics of the hearing aid), disturbing music, the sound of rain falling, human speech (babble), etc. or any sounds generated by the environment not of interest to the user. The picked-up sound may encode acoustic characteristics of the user and the user’s hearing aid style. The picked-up sound may be a superposition of the desired signal and the noise signal, i.e., the picked-up sound may be considered as a sum of the desired signal and the noise signal. The picked-up sound is typically referred to as a noisy signal to indicate that the picked-up sound comprises the desired signal and the noise signal. An audio input signal may be discrete-time signal in the hearing aid representing the picked-up sound.

An in-situ input signal may be based on the audio input signal. The in-situ input signal may be based on a time-frequency representation of the audio input signal. The time-frequency representation may be performed by an analysis filter bank. Thereby, the in-situ input signal is a signal or a processed version of the signal based on the sound in the environment. The in-situ input signal may encode acoustic characteristics of the user, the characteristics of the user’s hearing aid style, voice characteristics of the desired signal, or noise characteristics of noise signal. The acoustic characteristics of the user encoded in the in-situ input signal may include the user’s head-related transfer function, pinnae shape, own voice characteristics, etc. The in-situ input signal may encode characteristics of the hearing aid style of the user. The characteristics of the hearing aid style may include the microphone position on the hearing aid and shape of the hearing aid housing, or any mechanical features of the hearing aid that acoustically influences the sound picked-up by the microphone. The in-situ input signal may encode voice characteristics of the speaker of interest to the user. The voice characteristics may be speech articulation characteristics, frequency characteristics, speech rate, etc. of a speaker of interest. For example, a friend, a family member, or a teacher may be a speaker of interest for the user. The voice characteristics may be speech articulation characteristics, frequency characteristics, speech rate, etc. of a speaker of interest. For example, a friend, a family member, or a teacher may be a desired signal for the user.

The in-situ input signal may be represented in the time domain. The in-situ input signal may be represented in the frequency domain based on the discrete Fourier transform and wherein the in-situ input signal comprises a plurality of frequency bands. Each frequency band may be a representation a sinusoidal component constituting the in-situ input signal. The in-situ input signal may be represented in the time-frequency domain based on an analysis filter bank, e.g., the short-time Fourier transform and wherein the in-situ input signal comprises a plurality of time-frequency bands. Each time-frequency band may be a representation a sinusoidal component constituting the in-situ input signal at a given point in time.

The in-situ input signal obtained by a first hearing aid being worn by a first user may be considered as a generic noisy signal by a second hearing aid being worn by a second user. This is due to the in-situ input signal obtained by the first hearing aid is based on an audio input signal being independent with the second hearing aid or the second user. Hence, a generic noisy signal for a second hearing aid may be based on an in-situ input signal obtained by a first hearing aid being worn by a first user.

The method comprises obtaining a set of generic noise signals. A set of generic noise signals may be one or more generic noise signals. The generic noise signal may be a picked-up sound of a sound environment comprising a voice signal by an input transducer by another device than the hearing aid worn by the user. The another device may refer to a second hearing aid worn by a second user, or a sound recording system comprising an input transducer wherein the sound recording system is configured to pick-up sound from a sound environment.

The method for determining personalized training data for a user of a hearing aid comprises obtaining a set of generic clean speech signals. The generic clean speech signal may comprise a generic clean speech signal. The generic clean speech signal may be based on a picked-up voice signal by the another device in the sound environment. The sound environment may be in a sound studio without or little amount of noise and reverberation. The sound environment may comprise a human speaker instructed to articulate speech in close proximity to the input transducer of the sound recording system. The sound recording system may be configured to pick-up the articulated speech as sound. The generic clean speech signal may be the picked-up articulated speech. Thereby, the generic clean speech signal contains little to no noise.

The generic clean speech signal may be a synthetically generated speech signal. The generic clean speech signal may be a signal generated based on a signal generator function describing amplitude of the signal over time. The signal generator may be configured to generate a plurality of sinusoidal signals each characterized by a time-varying amplitude, a frequency, and a phase. The signal generator may be configured to generate a random signal characterized by a time-varying mean and variance. The signal generator function may comprise at least one parameter indicative of an amplitude, a frequency, a harmonic component, a variance, modulation, etc. The at least one parameter may be a function of time. The at least one parameter may be determined by the hearing aid user or a hearing care profession or a developer of the hearing aid.

The method comprises obtaining a set of generic noise signals. The generic noise signal may be a picked-up sound of a sound environment comprising a noise signal by an input transducer by another device than the hearing aid worn by the user. The sound environment may be in a noisy environment comprising one or more sound sources generating sound undesirable for the user. The sound environment may resemble a noisy street, a busy canteen, a noisy car, a blowing fan, etc.

The generic noise signal may be a synthetically generated noise signal. The generic noise signal may be a signal generated based on a signal generator function describing the amplitude of the signal over time. The signal generator may be configured to generate a plurality of sinusoidal signals each characterized by a time-varying amplitude, a frequency, and a phase. The signal generator may be configured to generate a random signal characterized by a time-varying mean and variance. The signal generator function may comprise at least one parameter indicative of an amplitude, a variance, modulation, etc. The at least one parameter may be a function of time. The at least one parameter may be determined by the hearing aid user or a hearing care profession or a developer of the hearing aid.

The generic noise signal may be a signal generated based on echo generator and/or reverberation generator. The echo generator may be configured to generate an echo signal based on a voice signal such as the generic clean speech signal. The echo generator may comprise a delay filter, wherein the echo generator may be configured to at least once delay the voice signal by a pre-defined number of samples and provide an echo signal. The echo signal may be the generic noise signal. The reverberation generator may be configured to generate a reverberation signal based on the voice signal such as the generic clean speech signal. The reverberation signal may comprise a reverberation filter comprising a plurality of reverberation filter coefficients. The reverberation filter coefficients may be based on a measured impulse response of a reverberant space such as an enclosed room (hall, stage, living room, car, etc.) or an open space (field, parking lot, forest, etc.). The reverberation filter coefficients may be determined by an algorithm such as the image source method or the finite element method. The generic noise signal may be determined based on filtering or convolving the generic clean speech signal with reverberation filter coefficients. The reverberation signal may be the generic noise signal.

Training data may comprise a set of generic desired signal and/or generic noise signal.

A generic noisy signal may be the sum of the generic clean speech signal and the generic noise signal.

The training data may comprise a set of generic clean speech signals. The training data may comprise a set of generic noise signals. The training data may comprise a set of generic clean speech signals and a set of generic noise signals. A set may be understood as one or more of a particular signal, such as one or more generic clean speech signals or one or more generic noise signals.

Personalized training data may comprise the training data and the in-situ input signals. The in-situ input signal may be based on the audio input signal provided by the input unit of the hearing aid being worn by the user. The in-situ input signal may be based on a time-frequency representation of the audio input signal. The time-frequency representation may be performed by an analysis filter bank. Thereby, the in-situ input signal is based on sounds in the environment that is of interest or relevance to the user. The in-situ input signal may encode acoustic characteristics of the user and the user’s hearing aid style. For example, the acoustic characteristics of the user encoded in the in-situ input signal may include the user’s head-related transfer function, pinnae shape, own voice characteristics, etc. The in-situ input signal may encode the hearing aid style of the user including the microphone position on the hearing aid and shape of the hearing aid housing, which acoustically influences the sound picked-up by the microphone. Thereby, personalized training data may be highly beneficial for example in the context of training a neural network, as the neural network can be trained on determined personalized training data that comprises signals that closely resembles sound that the user experiences on a daily basis.

The in-situ input signal may be represented in the time domain. The in-situ input signal may be represented in the frequency domain based on the discrete Fourier transform and wherein the in-situ input signal comprises a plurality of frequency bands. Each frequency band may be a representation a sinusoidal component constituting the in-situ input signal. The in-situ input signal may be represented in the time-frequency domain based on an analysis filter bank, e.g., the short-time Fourier transform and wherein the in-situ input signal comprises a plurality of time-frequency bands. Each time-frequency band may be a representation a sinusoidal component constituting the in-situ input signal at a given point in time.

The in-situ input signal obtained by a first hearing aid being worn by a first user may be considered as a generic noisy signal by a second hearing aid being worn by a second user. This is due to the in-situ input signal obtained by the first hearing aid is based on an audio input signal being independent with the second hearing aid or the second user. Hence, a generic noisy signal for a second hearing aid may be based on an in-situ input signal obtained by a first hearing aid being worn by a first user.

The method comprises receiving an audio input signal by an input unit constituting the hearing aid of the user. The audio input signal being the in-situ input signal. The method comprises receiving a plurality of audio input signals by an input unit constituting the hearing aid of the user. The plurality of audio input signal being the set of in-situ input signals.

The method comprises obtaining a set of in-situ input signals obtained by the hearing aid. The set of in-situ input signals may be one or more in-situ input signals. The set of in-situ input signals may be stored on the hearing aid or on an auxiliary device.

The in-situ input signal may comprise an in-situ voice signal and an in-situ-noise signal. The in-situ voice signal may be the voice signal of the audio input signal while the hearing aid is worn by the user. The in-situ-noise signal may be the noise signal of the audio input signal while the hearing aid is worn by the user. A sound environment may comprise a voice signal of interest to the user and a noise signal undesirable for the user. The input unit of the hearing aid will in such a sound environment pick-up the noisy signal, which is a superposition of the voice signal and the noise signal, and provide an audio input signal comprising the voice signal and the noise signal. The in-situ input signal may be based on the audio input signal. The in-situ voice signal may be based on the voice signal constituting the audio input signal. The in-situ-noise signal may be based on the noise signal constituting the audio input signal.

The method may comprise a voice activity detector. The voice activity detector may be configured to detect the presence of a voice signal in the in-situ input signal. The voice activity detector may be based on a minimum noise tracking method. The minimum noise tracking method may comprise a noise floor estimator configured to determine the noise floor of the in-situ input signal and provide a noise estimate which may be measured in decibels (dB), and a level estimator configured to determine the power of the in-situ input signal and provide a level estimate which may be measured in decibels (dB). The minimum noise tracking method may be configured to determine an a posteriori signal-to-noise ratio based on computing the ratio or difference between the level estimate and the noise estimate. The minimum noise tracking method may comprise a threshold with a pre-defined value, and wherein the minimum noise tracking method may be configured to provide a value of ‘1’ if the a posteriori signal-to-noise ratio is equal or above the threshold, representing the presence of a voice signal, and provide a value of ‘0’ if the a posteriori signal-to-noise ratio is below the threshold, representing the absence of a voice signal.

The method may comprise obtaining an in-situ input signal obtained by the hearing aid if the voice activity detector detects the presence of a voice signal in the in-situ input signal. The method may comprise obtaining a set of in-situ input signals obtained by the hearing aid if the voice activity detector detects the presence of voice signals in the in-situ input signals.

Thereby, the voice activity detector provides the advantage of only obtaining the in-situ voice signal, when a voice signal is detected in the in-situ input signal.

The method comprises determining a set of in-situ voice signals and a set of in-situ-noise signals based on the set of in-situ input signals.

The mode of operation may be determined based on a user input. The user input may be based on a physical interaction with the hearing aid such as a push on a first button on the hearing aid, so that when the first button is pushed, the hearing aid may operate in the noisy mode of operation or noise-only mode of operation. Thereby, this gives flexibility to the user to personalize the personalized training data by specifying which particular types of sound environments should be part of the personalized training data.

The method may comprise receiving a user input indicative of a mode of operation.

In some embodiments, the personalized training data may only contain in-situ input signals. The personalized training data that may be used to train a neural network.

The training data may comprise a set of generic clean speech signal and/or generic noise signal and/or in-situ voice signal and/or in-situ-noise signal. The personalized training data comprises a set of generic desired signal and generic noise signal and in-situ voice signal and in-situ-noise signal.

Thereby a method for provided personalized training data is provided. One advantage of the present disclosure is a method to acquire personalized training data comprising real-world audio signal with the hearing aid of the user and combine it with synthetically generated signals or generic audio signals acquired from a generic audio database. The acquired personalized training data may be used to train machine learning algorithms such as neural networks to estimate a desired voice signal in a noisy signal picked-up by the hearing aid microphones.

Determining the set of in-situ voice signals and the set of in-situ-noise signals may be based on the set in-situ input signal. Determining the set of in-situ voice signals and the set of in-situ-noise signals may comprise determining a plurality of target speech signals and a plurality of noise signals by providing the set of in-situ input signals to a source separator. Determining the set of in-situ voice signals may be based on the plurality of target speech signals. Determining the set of in-situ-noise signals may be based on the plurality of noise signals.

A source separator may comprise a source separation algorithm configured to provide a target speech signal based on an in-situ input signal. The source separation algorithm may be configured to provide a noise signal based on an in-situ input signal. The source separation algorithm may be configured to provide a target speech signal and a noise signal based on an in-situ input signal.

The source separation algorithm may be based on a masking algorithm. The masking algorithm may be configured to determine a target mask based on the in-situ input signal and provide the target speech signal by multiplying the target mask on the in-situ input signal. The masking algorithm may be configured to determine a noise mask based on the in-situ input signal and provide the noise signal by multiplying the noise mask on the in-situ input signal. The masking algorithm may be configured to determine a target mask and a noise mask based on the in-situ input signal and provide the target speech signal by multiplying the target mask on the in-situ input signal and provide the noise signal by multiplying the noise mask on the in-situ input signal. The target mask may be a value between 0 and 1. The noise mask may be a value between 0 and 1.

The masking algorithm may be based on a speech presence probability estimator given the in-situ input signal, wherein the speech presence probability estimator may provide a speech presence probability value indicative of the probability of speech in the in-situ input signal. The speech presence probability value may be the target mask. The value of 1 minus the speech presence probability value may be the noise mask. The speech presence probability value may be a value between 0 and 1. The speech presence probability value may be a conditional probability of the presence of speech in the in-situ input signal given the in-situ input signal.

The source separator may be based on a voice activity detector. The voice activity detector may be based on the target mask and/or the noise mask or the speech presence probability estimator. The voice activity detector may provide a voice activity detection value based on the target mask and/or noise mask. The voice activity detector may comprise a threshold. The threshold may comprise a value between0 and 1. The threshold may comprise a value between 0.3 to 0.8. The threshold may comprise a value of 0.5 or 0.6 or 0.7 or 0.8 or 0.9. The voice activity detector may output a value of 1 when the target mask is above or equal to the threshold indicative of a speech dominated region. The voice activity detector may output a value of 0 when the target mask is below the threshold indicative of a noise dominated region. The voice activity detector may output a value of 0 when the noise mask is above or equal to the threshold. The voice activity detector may output a value of 1 when the noise mask is below the threshold. The voice activity detector may provide a voice activity detection value based on the speech presence probability value. The source separator may be configured to multiply the voice activity detection value on the in-situ input signal and provide the target speech signal and/or the noise signal.

The source separator may comprise an analysis filter bank configured to provide a plurality sub-band input signals based on the in-situ input signal. The plurality of sub-band input signals may be the in-situ input signal being segmented into a plurality of frames and transformed into the time-frequency domain such that each frame is represented with a plurality of complex values each representing a sinusoidal component at a frequency band. The plurality of sub-band input signals may be the plurality of complex values. The analysis filter bank may comprise the short-time Fourier transform. The masking algorithm may be configured to determine a target mask and/or a noise mask for each of the plurality of sub-band input signals. The masking algorithm may provide a plurality of masked target speech signals based on multiplying each target mask on the respective sub-band input signal. The plurality of masked target speech signals. The target speech signal may be the plurality of masked target speech signals. The masking algorithm may provide a plurality of masked noise signals based on multiplying each noise mask on the respective sub-band input signal. The noise signal may be the plurality of masked noise signals. The voice activity detector may comprise a first threshold and/or a second threshold between a value of 0 and 1 for each sub-band input signal and provide a voice activity detection value for each first and second threshold. If the sub-band input signal is above or equal to the first threshold the voice activity detection value may be indicative of a speech dominated region. If the sub-band input signal is below the first threshold the voice activity detection value may be indicative of a noise dominated region. If the sub-band input signal is above or equal to the second threshold the voice activity detection value may be indicative of a noise dominated region. If the sub-band input signal is below the second threshold the voice activity detection value may be indicative of a speech dominated region. The source separator may be configured to multiply each voice activity detection value on the respective sub-band signal and provide the target speech signal and/or the noise signal.

Determining the set of in-situ voice signals and the set of in-situ-noise signals may be based on the set in-situ input signal. Determining the set of in-situ voice signals and the set of in-situ-noise signals may comprise determining noise dominated regions and speech dominated regions by providing the set of in-situ signals to a voice activity detector or a masking algorithm. The set of in-situ voice signals may be one or more target speech signals provided by the source separator. The set of in-situ-noise signals may be one or more noise signals provided by the source separator.

Determining the set of in-situ voice signals and the set of in-situ-noise signals may comprise determining the set of in-situ-noise signals based on the noise dominated regions. The noise dominated regions may be determined based on the voice activity detector or a masking algorithm. Determining the set of in-situ voice signals and the set of in-situ-noise signals may comprise determining the set of in-situ voice signals based on the voice dominated regions. The voice dominated regions may be determined based on the voice activity detector or a masking algorithm.

The set of generic noise signals may comprise signals recorded by a sound engineer. The set of generic noise signals may comprise signals recorded by other hearing aids worn by other users. The set of generic noise signals may comprise synthetically generated signals. The set of generic noise signals may comprise one or more of the following: signals recorded by a sound engineer, signals recorded by other hearing aids worn by other users, and synthetically generated signals.

The set of generic clean speech signals may comprise signals recorded by a sound engineer. The set of generic clean speech signals may comprise signals recorded by other hearing aids worn by other users. The set of generic clean speech signals may comprise synthetically generated signals. The set of generic clean speech signals comprises one or more of the following: signals recorded by a sound engineer, signals recorded by other hearing aids worn by other users, and synthetically generated signals.

The personalized training data set may be based on the set of in-situ voice signals. The personalized training data set may be based on the set of in-situ-noise signals. The personalized training data set may be based on the set of generic noise signals. The personalized training data set may be based on the set of generic clean speech signals. Determining the personalized training data may comprise determining a set of training pairs. Each training pair may comprise a training input and a training target. The training target may be based on the set of generic clean speech signals. The training target may be based on the set of in-situ speech signals. The training input may be based on a combination of the training target and the set of generic noise signals. The training input may be based on a combination of the training target and the set of in-situ-noise signals.

Determining a personalized neural network parameter may be based on the personalized training data set. Determining a personalized neural network may be based on the personalized neural network parameter. Processing an input signal obtained by the hearing aid may be based on using the personalized neural network to determine a processed signal.

The personalized neural network parameter may comprise one or more weights for a neural network. A weight may be a scalar value.

The method may comprise obtaining a hearing aid parameter associated with the hearing aid.

Determining a personalized neural network parameter may be based on the personalized training data set. Determining a personalized neural network parameter may be based on the hearing aid parameter.

The hearing aid parameter may be a battery level indicative of the remaining battery level of the hearing aid. The hearing aid parameter may be a wireless link quality to external device. The hearing aid parameter may be used in combination with a threshold, such that when the device parameter is above the threshold, the hearing aid may transmit the in-situ input signal to external device.

A hearing aid status parameter may be a docking status of the hearing aid indicative of whether the hearing aid is docked in a docking station. The docking station may be used to charge the hearing aid. The hearing aid may be configured to transmit a set of in-situ input signals to an auxiliary device when docked. The hearing aid may be configured to transmit a set of in-situ voice signals to an auxiliary device. The hearing aid may be configured to transmit a set of in-situ noise signals to an auxiliary device when docked. The transmission may be wireless by a hearing aid interface. The transmission may be wired through a wired connection from the docking station to an auxiliary device.

The hearing aid parameter may be a processing parameter. The hearing aid parameter may be one or more weights of a trained neural network on the hearing aid. The hearing aid parameter may be an environmental parameter indicative of the sound environment. The environmental parameter may be a signal-to-noise ratio, a noise level, a sound level, etc. The hearing aid parameter may be a noise reduction parameter determined by the hearing aid. The noise reduction parameter may be a beamformer weight, an a posteriori SNR, an a posteriori SNR, filter gains, compression level, amplification, etc.

The hearing aid parameter may be a combination of the device parameter and the processing parameter.

The method may be performed by the hearing aid. The hearing aid may comprise a digital signal processor configured to perform the method. The method may be performed by a hearing aid and an auxiliary device. The method may be performed by the hearing aid and an auxiliary device.

In another aspect of the present application, a hearing aid system for a self-learning hearing aid comprises a hearing aid. The hearing aid may comprise one or more input transducers. The one or more input transducers may be configured to obtain a set of in-situ input signals. The hearing aid may comprise a hearing aid interface for transmitting and receiving signals. The hearing aid may comprise a hearing aid processor comprising a hearing aid neural network.

The hearing aid system comprises a hearing aid comprising an input unit comprising an input transducer or a plurality of input transducers. The input transducer may be a microphone or any transducer being configured to pick-up sound and convert the picked-up sound to an electric signal representing sound of an environment. The input unit may be configured to provide an audio input signal. The input unit may be configured to provide a plurality of audio input signals. The audio input signal may be based on the electric signal provided by the input transducer. The audio input signal may be a sequence of samples representing an amplitude and a timestamp based on the electric signal.

The audio input signal may represent the noisy signal. Therefore, one goal of the hearing aid is to determine the desired signal and/or the noise signal and provide a processed signal based on the audio input signal and or the determined the desired signal and/or the noise signal. The desired signal and/or the noise signal may be determined by using a machine learning algorithm such as a trained neural network comprising a plurality of trained neural network weights based on the audio input signal.

A user may be understood as a user of the hearing aid. The hearing aid user may wear the hearing aid by mounting the hearing aid for example behind the ear or in the ear canal of the user. The hearing aid may be configured to pick-up sound while the hearing aid is being worn by the user and provide the audio input signal.

The hearing aid system may comprise an auxiliary device. The auxiliary device may comprise an auxiliary interface for transmitting and receiving signals. The auxiliary device may comprise an auxiliary processor. The auxiliary processor may comprise a neural network adaptor. The hearing aid interface may be configured to transmit the set of in-situ input signals to allow for determining a personalized training data set at an external device. The neural network adaptor may be configured to receive the personalized training data set. The neural network adaptor may be configured to determine a personalized neural network parameter for the hearing aid neural network based on the personalized training data. The auxiliary interface may be configured to transmit the personalized neural network parameter to the hearing aid. The hearing aid processor may be configured to determine an updated hearing aid neural network based on the personalized neural network parameter. The hearing aid processor may be configured to determine the updated hearing aid neural network based on the hearing aid neural network. The hearing aid neural network may be configured to receive an input signal. The hearing aid neural network may be configured to determine a processed signal based on the updated hearing aid neural network.

A self-learning hearing aid may be understood as a hearing aid comprising an updated hearing aid neural network. The updated hearing aid neural network may be determined based on a personalized neural network parameter. The personalized neural network parameter may be determined based on the personalized training data set.

A hearing aid interface may comprise a first wireless transceiver configured to receive and transmit wireless data such as parameters and signals. The first wireless transceiver may be configured to transmit an in-situ input signal or a processed version thereof to an external device such as the auxiliary device. The first wireless transceiver may be configured to transmit a set of in-situ input signals or processed versions thereof to another. The first wireless transceiver may be configured to receive a personalized neural network parameter from the external device. The first wireless transceiver may be configured to receive an updated hearing aid neural network from the external device.

A hearing aid processor may comprise a digital signal processor configured to process one or more audio input signals or processed versions thereof. The hearing aid processor may be configured to carry out additions, subtraction, multiplications, look-ups, and divisions, or other algorithmic manipulations on the audio input signals. The hearing aid may comprise a memory unit configured to store parameters, instructions, or signals. The parameters may comprise constants, coefficients, look-up tables, hearing aid neural network parameters, etc. The signals may comprise the audio input signals or processed versions thereof, a set of in-situ input signals, or any other quantity measured by an input transducer constituting the hearing aid. The instructions may comprise algorithms such as hearing aid neural network architectures, filters, compression, or any other sequence of arithmetic that need to be executed on the hearing aid processor. The hearing aid processor may be configured to provide a processed signal by processing the audio input signals based on the stored parameters and instructions. The stored parameters and instructions may constitute the hearing aid neural network constituting the hearing aid processor.

An auxiliary interface may comprise a second wireless transceiver configured to receive and transmit wireless data such as parameters and signals. The second wireless transceiver may be configured to transmit the a personalized neural network parameter to the hearing aid. The second wireless transceiver may be configured to transmit the updated hearing aid neural network to the hearing aid. The second wireless transceiver may be configured to receive an in-situ input signal or a processed version thereof. The second wireless transceiver may be configured to receive a set of in-situ input signals or processed versions thereof.

The hearing aid may comprise a neural network comprising the personalized neural network parameter. The neural network may comprise model layers for processing of an input signal, or a signal based thereon to provide a processed signal. The model layers may comprise an input layer, one or more intermediate layers, and an output layer. Each layer may comprise one or more nodes. The input layer of the neural network may be viewed as the layer where data, such as the input signal, is fed into the neural network. Each node in the input layer may represent a feature of the input data. The one or more intermediate layers may perform various computations and transformations on the input data to extract features and patterns. Each node in the one or more intermediate layers may receive one or more inputs from the previous layer, determine a weighted sum or a filtered output based on the one or more inputs from the previous layer, add a bias to the weighted sum a filtered output to determine a result, and then pass the result through an activation function to introduce non-linearity. The activation function may be, e.g., a sigmoid function, a softmax function, a rectified linear unit (ReLU) function, tangent hyperbolic function, etc. The weights of the weighted sum or filtered output may be based on the personalized neural network parameter. The output layer may be viewed as the final layer that provides the network’s predictions or outputs. The output layer may comprise an output activation function, e.g., a linear function, a sigmoid function, a softmax function, etc. The processed signal may be the network’s predictions or outputs. Each node in the output layer may correspond to a possible output or class label.

The neural network may be configured to provide an in-situ voice signal based on the in-situ input signal. The neural network may be configured to provide an in-situ noise signal based on the in-situ input signal. The neural network may be configured to provide a target mask based on the in-situ input signal. The neural network may be configured to provide a noise mask based on the in-situ input signal. The neural network may be configured to provide a voice activity detection value based on the in-situ input signal.

The neural network may be a trained neural network. To train the neural network, the neural network may be initialized with initial values for parameters of the neural network, such initialization may be carried out by known methods, e.g., Xavier initialization or He initialization, alternatively, the neural network may be initialized with parameters determined during a prior training session of the neural network. The initialized neural network may be provided with training data to produce one or more outputs. The training data may be provided as labelled data, or unlabeled data. The training data may be based on the personalized training data. The training data may be provided in pairs, each pair comprising an input sample to be provided as an input to the neural network, and a ground truth. The input sample may be based on the in-situ input signal. The ground truth may be the true underlying voice activity of the desired signal, e.g., the target speech signal, constituting the in-situ input signal.

The one or more outputs of the neural network may be provided to a cost function configured to determine a cost based on the difference between the one or more outputs of the neural network and a target. The target may be provided as part of the training data, e.g., as the ground truth or a label associated with the data. The target may be a target value, e.g., a mean opinion score or a signal-to-noise ratio or a voice activity value. To train the neural network one or more parameters of the neural network are adjusted to minimize the cost of the cost function. The cost function may be, e.g., the binary cross-entropy function, the cross-entropy function, Kullback-Leibler divergence, mean-square-error function, mean-absolute-error function, a speech intelligibility or speech quality measure (e.g., speech distortion or speech intelligibility index). The one or more parameters of the neural network may be adjusted according to an optimization algorithm, such as stochastic gradient descent, or Levenberg- Marquardt optimization. Training of the neural network may be iterated over multiple epochs. Each epoch may comprise passing the entire training dataset through the network and updating the neural network parameters accordingly.

In a particular embodiment, the method comprises using a source separator comprising a pre-trained neural network. The method comprises using a pre-trained neural network to provide a plurality of target masks in the time-frequency domain and a plurality of noise masks in the time-frequency domain based on the in-situ input signal. The method comprises using a first threshold. The method comprises providing a voice activity detection values of ‘1’ for each target mask indicative of a speech dominant region if the target mask is above the first threshold. The method comprises using a second threshold. The method comprises providing a noise-only detection value of ‘1’ for each noise mask indicative of a noise dominant region

if the noise mask is above the second threshold. The method comprises using the voice activity detection value to provide the in-situ voice signal based on multiplying the voice activity detection value on the in-situ input signal represented in the time-frequency domain. The method comprises using the noise-only detection value to provide the in-situ noise signal by multiplying the noise-only detection value on the in-situ input signal represented in the time-frequency domain.

The pre-trained neural network may be trained according to a pre-training method based on non-personalized training data. The non-personalized training data may comprise a set of generic clean speech signals and generic noise signals. The pre-training method may comprise providing a set of generic noisy signals by mixing generic clean speech signals with generic noise signals. The pre-training method may comprise providing a pre-training pair. The pre-training pair may comprise the noisy signal as a training input to the neural network and the ground truth of voice activity of the generic clean speech signal as the training target. The pre-training method may comprise determining the ground truth of voice activity of the generic clean speech signal. Determining the ground truth of voice activity of the generic clean speech signal may be based on a level estimator configured to provide an estimate of the signal power of the generic clean speech signal over time. The pre-training method may comprise a threshold. If the estimated signal power of the generic clean speech signal is above or equal to the threshold, the ground truth of voice activity of the generic clean speech signal may be equal to 1 representing voice activity. If the estimated signal power of the generic clean speech signal is below the threshold, the ground truth of voice activity of the generic clean speech signal may be equal to 0 representing voice absence.

A neural network adaptor may be based on an algorithm configured to determine the personalized neural network parameter using the personalized training data. The algorithm may be based on a cost function and an optimization algorithm. The neural network adaptor may be configured to determine the personalized neural network parameters by generating a plurality of training pairs from the personalized training data such that each training pair comprises a training target (e.g., an in-situ voice signal) and a training input (e.g., a combination of an in-situ voice signal and an in-situ-noise signal). For example, the training input may be a combination (e.g., linear combination) of an in-situ voice signal and an in-situ noise signal and the training target may be the corresponding in-situ voice signal. The neural network adaptor may use an initial neural network parameter of the hearing aid neural network as neural network parameters for determining the personalized neural network parameter. The current neural network parameters may be received be the auxiliary device from the hearing aid. The neural network adaptor may be configured to provide an estimated target by forward propagating the training input using the initial neural network parameters. The neural network adaptor may be configured to determine gradient based on a backpropagation algorithm and the cost function. The neural network adaptor may be configured to adjust the weights of the neural network based on the gradient to provide an updated neural network parameter. The neural network adaptor may be configured to continue updating the neural network parameter based on a new training pair. The neural network adaptor may be configured to stop updating the neural network parameter until a stopping criterion is met. The neural network adaptor may be configured to determine the personalized neural network parameters based on the neural network parameter where the stopping criterion is met.

An updated hearing aid neural network may be the hearing aid neural network where the neural network parameters are the personalized neural network parameters.

An input signal may be the audio input signal received by the hearing aid input transducers.

The processed signal may be the output of the updated hearing aid neural network using the personalized neural network parameters to process the input signal or a processed version thereof. The processed signal may a processed version of the output of the updated hearing aid neural network.

Obtaining the in-situ input signal may comprise obtaining hearing aid status parameter. The status parameter may be a hearing aid battery level indicative of the amount of battery left on the battery of the hearing aid. The status parameter may be a wireless link quality indicative of the link quality between the hearing aid and the auxiliary device. The status parameter may be a docking status parameter indicative of whether the hearing aid is docked in the a docking station for the hearing aid for charging or configuration.

The hearing aid may be configured to obtain the hearing aid status parameter and transmit the hearing aid status parameter to the external device. The auxiliary device may be configured to receive the hearing aid status parameter.

Obtaining the in-situ input signal may comprise comparing the hearing aid status parameter with a threshold. The threshold may be a pre-determined value set by an engineer or a hearing care professional. The auxiliary device may comprise the threshold.

Obtaining the in-situ input signal may comprise if the hearing aid status parameter exceeds the threshold, the hearing aid may be configured to transmit the set of in-situ input signals to the external device. The external device may be the auxiliary device. Obtaining the in-situ input signal may comprise if the hearing aid status parameter indicative of a battery level exceeds the threshold indicative of a minimum battery level. Obtaining the in-situ input signal may comprise if the hearing aid status parameter indicative of a wireless link quality level exceeds the threshold indicative of a minimum wireless link quality. Obtaining the in-situ input signal may comprise if the hearing aid status parameter indicative of a docking status exceeds the threshold or is equal to a value of 1 indicative of the hearing aid being docked in a docking station for the hearing aid.

In a further aspect, a hearing aid system comprising a hearing aid as described above, in the ‘detailed description of embodiments’, and in the claims.

The hearing aid system may be adapted to establish a communication link between the hearing aid and the auxiliary device to provide that information (e.g. control and status signals, possibly audio signals) can be exchanged or forwarded from one to the other.

The auxiliary device may be constituted by or comprise a remote control, a smartphone, or other portable or wearable electronic device, such as a smartwatch or the like.

The auxiliary device may be constituted by or comprise a remote control for controlling functionality and operation of the hearing aid(s). The function of a remote control may be implemented in a smartphone, the smartphone possibly running an APP allowing to control the functionality of the audio processing device via the smartphone (the hearing aid(s) comprising an appropriate wireless interface to the smartphone, e.g. based on Bluetooth or some other standardized or proprietary scheme).

The auxiliary device may be constituted by or comprise an audio gateway device adapted for receiving a multitude of audio signals (e.g. from an entertainment device, e.g. a TV or a music player, a telephone apparatus, e.g. a mobile telephone or a computer, e.g. a PC, a wireless microphone, etc.) and adapted for selecting and/or combining an appropriate one of the received audio signals (or combination of signals) for transmission to the hearing aid.

The auxiliary device may be constituted by or comprise another hearing aid. The hearing system may comprise two hearing aids adapted to implement a binaural hearing system, e.g. a binaural hearing aid system.

In another aspect of the present disclosure, a self-learning hearing aid may comprise one or more input transducers. The one or more input transducer may be configured to obtain a set of in-situ input signals. The self-learning hearing aid may comprise a hearing aid processor The hearing aid processor may be configured to determine a set of personalized training data based on the set of in-situ input signals. The processor may be configured to receive the set of personalized training data. The processor may be configured to determine a personalized neural network parameter for the hearing aid neural network based on the personalized training data. The hearing aid processor may be configured to update the hearing aid neural network based on the personalized neural network parameter. The hearing aid processor may be configured to receive an input signal. The hearing aid processor may be configured to determine a processed signal based on the updated neural network.

The hearing aid may be adapted to provide a frequency dependent gain and/or a level dependent compression and/or a transposition (with or without frequency compression) of one or more frequency ranges to one or more other frequency ranges, e.g. to compensate for a hearing impairment of a user. The hearing aid may comprise a signal processor for enhancing the input signals and providing a processed output signal.

The hearing aid may comprise an output unit for providing a stimulus perceived by the user as an acoustic signal based on a processed electric signal. The output unit may a vibrator of a bone conducting hearing aid. The output unit may comprise an output transducer. The output transducer may comprise a receiver (loudspeaker) for providing the stimulus as an acoustic signal to the user (e.g. in an acoustic (air conduction based) hearing aid). The output transducer may comprise a vibrator for providing the stimulus as mechanical vibration of a skull bone to the user (e.g. in a bone-attached or bone-anchored hearing aid). The output unit may (additionally or alternatively) comprise a (e.g. wireless) transmitter for transmitting sound picked up-by the hearing aid to another device, e.g. a far-end communication partner (e.g. via a network, e.g. in a telephone mode of operation).

The hearing aid may comprise an input unit for providing an electric input signal representing sound. The input unit may comprise an input transducer, e.g. a microphone, for converting an input sound to an electric input signal. The input unit may comprise a wireless receiver for receiving a wireless signal comprising or representing sound and for providing an electric input signal representing said sound.

The wireless receiver and/or transmitter may e.g. be configured to receive and/or transmit an electromagnetic signal in the radio frequency range (3 kHz to 300 GHz). The wireless receiver and/or transmitter may e.g. be configured to receive and/or transmit an electromagnetic signal in a frequency range of light (e.g. infrared light 300 GHz to 430 THz, or visible light, e.g. 430 THz to 770 THz).

The hearing aid may comprise a directional microphone system adapted to spatially filter sounds from the environment, and thereby enhance a target acoustic source among a multitude of acoustic sources in the local environment of the user wearing the hearing aid. The directional system may be adapted to detect (such as adaptively detect) from which direction a particular part of the microphone signal originates. This can be achieved in various different ways as e.g. described in the prior art. In hearing aids, a microphone array beamformer is often used for spatially attenuating background noise sources. The beamformer may comprise a linear constraint minimum variance (LCMV) beamformer. Many beamformer variants can be found in literature. The minimum variance distortionless response (MVDR) beamformer is widely used in microphone array signal processing. Ideally the MVDR beamformer keeps the signals from the target direction (also referred to as the look direction) unchanged, while attenuating sound signals from other directions maximally. The generalized sidelobe canceller (GSC) structure is an equivalent representation of the MVDR beamformer offering computational and numerical advantages over a direct implementation in its original form.

Most sound signal sources (except the user’s own voice) are located far way from the user compared to dimensions of the hearing aid, e.g. a distance d_{mic} between two microphones of a directional system. A typical microphone distance in a hearing aid is of the order 10 mm. A minimum distance of a sound source of interest to the user (e.g. sound from the user’s mouth or sound from an audio delivery device) is of the order of 0.1 m (> 10 d_{mic}). For such minimum distances, the hearing aid (microphones) would be in the acoustic near-field of the sound source and a difference in level of the sound signals impinging on respective microphones may be significant. A typical distance for a communication partner is more than 1 m (>100 d_{mic}). The hearing aid (microphones) would be in the acoustic far-field of the sound source and a difference in level of the sound signals impinging on respective microphones is insignificant. The difference in time of arrival of sound impinging in the direction of the microphone axis (e.g. the front or back of a normal hearing aid) is ΔT= d_{mic}/v_{sound}=0.01/343 [s]=29 µs, where v_{sound} is the speed of sound in air at 20°C (343 m/s).

The hearing aid may comprise antenna and transceiver circuitry allowing a wireless link to an entertainment device (e.g. a TV-set), a communication device (e.g. a telephone), a wireless microphone, a separate (external) processing device, or another hearing aid, etc. The hearing aid may thus be configured to wirelessly receive a direct electric input signal from another device. Likewise, the hearing aid may be configured to wirelessly transmit a direct electric output signal to another device. The direct electric input or output signal may represent or comprise an audio signal and/or a control signal and/or an information signal.

In general, a wireless link established by antenna and transceiver circuitry of the hearing aid can be of any type. The wireless link may be a link based on near-field communication, e.g. an inductive link based on an inductive coupling between antenna coils of transmitter and receiver parts. The wireless link may be based on far-field, electromagnetic radiation. Preferably, frequencies used to establish a communication link between the hearing aid and the other device is below 70 GHz, e.g. located in a range from 50 MHz to 70 GHz, e.g. above 300 MHz, e.g. in an ISM range above 300 MHz, e.g. in the 900 MHz range or in the 2.4 GHz range or in the 5.8 GHz range or in the 60 GHz range (ISM=Industrial, Scientific and Medical, such standardized ranges being e.g. defined by the International Telecommunication Union, ITU). The wireless link may be based on a standardized or proprietary technology. The wireless link may be based on Bluetooth technology (e.g. Bluetooth Low-Energy technology, e.g. LE audio), or Ultra WideBand (UWB) technology.

The hearing aid may be constituted by or form part of a portable (i.e. configured to be wearable) device, e.g. a device comprising a local energy source, e.g. a battery, e.g. a rechargeable battery. The hearing aid may e.g. be a low weight, easily wearable, device, e.g. having a total weight less than 100 g, such as less than 20 g, such as less than 5 g.

The hearing aid may comprise a ‘forward’ (or ‘signal’) path for processing an audio signal between an input and an output of the hearing aid. A signal processor may be located in the forward path. The signal processor may be adapted to provide a frequency dependent gain according to a user’s particular needs (e.g. hearing impairment). The hearing aid may comprise an ‘analysis’ path comprising functional components for analyzing signals and/or controlling processing of the forward path. Some or all signal processing of the analysis path and/or the forward path may be conducted in the frequency domain, in which case the hearing aid comprises appropriate analysis and synthesis filter banks. Some or all signal processing of the analysis path and/or the forward path may be conducted in the time domain.

An analogue electric signal representing an acoustic signal may be converted to a digital audio signal in an analogue-to-digital (AD) conversion process, where the analogue signal is sampled with a predefined sampling frequency or rate fₛ, fₛ being e.g. in the range from 8 kHz to 48 kHz (adapted to the particular needs of the application) to provide digital samples xₙ (or x[n]) at discrete points in time tₙ (or n), each audio sample representing the value of the acoustic signal at tₙ by a predefined number N_{b} of bits, N_{b} being e.g. in the range from 1 to 48 bits, e.g. 24 bits. Each audio sample is hence quantized using N_{b} bits (resulting in 2^{Nb} different possible values of the audio sample). A digital sample x has a length in time of 1/fₛ, e.g. 50 μs, for f s = 20 kHz. A number of audio samples may be arranged in a time frame. A time frame may comprise 64 or 128 audio data samples. Other frame lengths may be used depending on the practical application.

The hearing aid may comprise an analogue-to-digital (AD) converter to digitize an analogue input (e.g. from an input transducer, such as a microphone) with a predefined sampling rate, e.g. 20 kHz. The hearing aids may comprise a digital-to-analogue (DA) converter to convert a digital signal to an analogue output signal, e.g. for being presented to a user via an output transducer.

The hearing aid, e.g. the input unit, and or the antenna and transceiver circuitry may comprise a transform unit for converting a time domain signal to a signal in the transform domain (e.g. frequency domain or Laplace domain, Z transform, wavelet transform, etc.). The transform unit may be constituted by or comprise a TF-conversion unit for providing a time-frequency representation of an input signal. The time-frequency representation may comprise an array or map of corresponding complex or real values of the signal in question in a particular time and frequency range. The TF conversion unit may comprise a filter bank for filtering a (time varying) input signal and providing a number of (time varying) output signals each comprising a distinct frequency range of the input signal. The TF conversion unit may comprise a Fourier transformation unit (e.g. a Discrete Fourier Transform (DFT) algorithm, or a Short Time Fourier Transform (STFT) algorithm, or similar) for converting a time variant input signal to a (time variant) signal in the (time-)frequency domain. The frequency range considered by the hearing aid from a minimum frequency fₘᵢₙ to a maximum frequency fₘₐₓ may comprise a part of the typical human audible frequency range from 20 Hz to 20 kHz, e.g. a part of the range from 20 Hz to 12 kHz. Typically, a sample rate fₛ is larger than or equal to twice the maximum frequency fₘₐₓ, fₛ ≥ 2fₘₐₓ. A signal of the forward and/or analysis path of the hearing aid may be split into a number NI of frequency bands (e.g. of uniform width), where NI is e.g. larger than 5, such as larger than 10, such as larger than 50, such as larger than 100, such as larger than 500, at least some of which are processed individually. The hearing aid may be adapted to process a signal of the forward and/or analysis path in a number NP of different frequency channels (NP ≤ NI). The frequency channels may be uniform or non-uniform in width (e.g. increasing in width with frequency), overlapping or non-overlapping.

The hearing aid may be configured to operate in different modes, e.g. a normal mode and one or more specific modes, e.g. selectable by a user, or automatically selectable. A mode of operation may be optimized to a specific acoustic situation or environment, e.g. a communication mode, such as a telephone mode. A mode of operation may include a low-power mode, where functionality of the hearing aid is reduced (e.g. to save power), e.g. to disable wireless communication, and/or to disable specific features of the hearing aid.

The hearing aid may comprise a number of detectors configured to provide status signals relating to a current physical environment of the hearing aid (e.g. the current acoustic environment), and/or to a current state of the user wearing the hearing aid, and/or to a current state or mode of operation of the hearing aid. Alternatively or additionally, one or more detectors may form part of an external device in communication (e.g. wirelessly) with the hearing aid. An external device may e.g. comprise another hearing aid, a remote control, and audio delivery device, a telephone (e.g. a smartphone), an external sensor, etc.

One or more of the number of detectors may operate on the full band signal (time domain). One or more of the number of detectors may operate on band split signals ((time-) frequency domain), e.g. in a limited number of frequency bands.

The number of detectors may comprise a level detector for estimating a current level of a signal of the forward path. The detector may be configured to decide whether the current level of a signal of the forward path is above or below a given (L-)threshold value. The level detector operates on the full band signal (time domain). The level detector operates on band split signals ((time-) frequency domain).

The hearing aid may comprise a voice activity detector (VAD) for estimating whether or not (or with what probability) an input signal comprises a voice signal (at a given point in time). A voice signal may in the present context be taken to include a speech signal from a human being. It may also include other forms of utterances generated by the human speech system (e.g. singing). The voice activity detector unit may be adapted to classify a current acoustic environment of the user as a VOICE or NO-VOICE environment. This has the advantage that time segments of the electric microphone signal comprising human utterances (e.g. speech) in the user’s environment can be identified, and thus separated from time segments only (or mainly) comprising other sound sources (e.g. artificially generated noise). The voice activity detector may be adapted to detect as a VOICE also the user’s own voice. Alternatively, the voice activity detector may be adapted to exclude a user’s own voice from the detection of a VOICE.

The hearing aid may comprise an own voice detector for estimating whether or not (or with what probability) a given input sound (e.g. a voice, e.g. speech) originates from the voice of the user of the system. A microphone system of the hearing aid may be adapted to be able to differentiate between a user’s own voice and another person’s voice and possibly from NON-voice sounds.

The hearing aid may comprise an acoustic (and/or mechanical) feedback control (e.g. suppression) or echo-cancelling system. Adaptive feedback cancellation has the ability to track feedback path changes over time. It is typically based on a linear time invariant filter to estimate the feedback path but its filter weights are updated over time. The filter update may be calculated using stochastic gradient algorithms, including some form of the Least Mean Square (LMS) or the Normalized LMS (NLMS) algorithms. They both have the property to minimize the error signal in the mean square sense with the NLMS additionally normalizing the filter update with respect to the squared Euclidean norm of some reference signal.

The hearing aid may further comprise other relevant functionality for the application in question, e.g. compression, noise reduction, etc.

The hearing aid may comprise a hearing instrument, e.g. a hearing instrument adapted for being located at the ear or fully or partially in the ear canal of a user.

### BRIEF DESCRIPTION OF DRAWINGS

The aspects of the disclosure may be best understood from the following detailed description taken in conjunction with the accompanying figures. The figures are schematic and simplified for clarity, and they just show details to improve the understanding of the claims, while other details are left out. Throughout, the same reference numerals are used for identical or corresponding parts. The individual features of each aspect may each be combined with any or all features of the other aspects. These and other aspects, features and/or technical effect will be apparent from and elucidated with reference to the illustrations described hereinafter in which:

FIG. 1 shows a flow diagram, showing the steps for determining personalized data for a user of a hearing aid according to the present disclosure.

FIG. 2 shows an exemplary block diagram, showing a method that may be used for determining personalized data for a user of a hearing aid according to the present disclosure.

FIG. 3 shows an exemplary block diagram, showing a method that may be used for determining personalized data for a user of a hearing aid, and wherein the in-situ voice signal and the in-situ noise signal are determined based on a source separator according to the present disclosure.

FIG. 4 shows an exemplary block diagram, showing a method that may be used for determining personalized data for a user of a hearing aid, and wherein the determination of the generic speech signal and the generic noise signal are determined based on an estimated signal-to-noise ratio.

FIG. 5 shows an exemplary block diagram of a hearing aid system comprising a hearing aid an auxiliary device according to the present disclosure.

FIG. 6 shows an exemplary block diagram of a hearing aid according to the present disclosure.

The figures are schematic and simplified for clarity, and they just show details which are essential to the understanding of the disclosure, while other details are left out. Throughout, the same reference signs are used for identical or corresponding parts.

Further scope of applicability of the present disclosure will become apparent from the detailed description given hereinafter. However, it should be understood that the detailed description and specific examples, while indicating preferred embodiments of the disclosure, are given by way of illustration only. Other embodiments may become apparent to those skilled in the art from the following detailed description.

### DETAILED DESCRIPTION OF EMBODIMENTS

The detailed description set forth below in connection with the appended drawings is intended as a description of various configurations. The detailed description includes specific details for the purpose of providing a thorough understanding of various concepts. However, it will be apparent to those skilled in the art that these concepts may be practiced without these specific details. Several aspects of the apparatus and methods are described by various blocks, functional units, modules, components, circuits, steps, processes, algorithms, etc. (collectively referred to as “elements”). Depending upon particular application, design constraints or other reasons, these elements may be implemented using electronic hardware, computer program, or any combination thereof.

The electronic hardware may include micro-electronic-mechanical systems (MEMS), integrated circuits (e.g. application specific), microprocessors, microcontrollers, digital signal processors (DSPs), field programmable gate arrays (FPGAs), programmable logic devices (PLDs), gated logic, discrete hardware circuits, printed circuit boards (PCB) (e.g. flexible PCBs), and other suitable hardware configured to perform the various functionality described throughout this disclosure, e.g. sensors, e.g. for sensing and/or registering physical properties of the environment, the device, the user, etc. Computer program shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

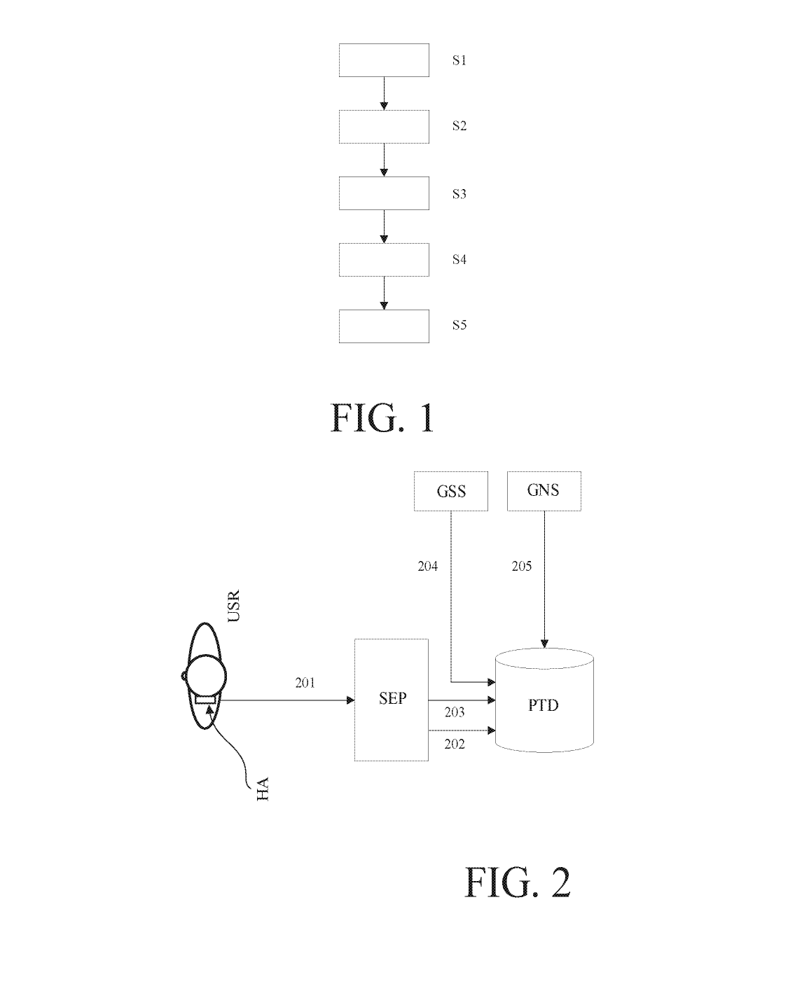

FIG. 1 shows a flow diagram, showing the steps for determining personalized data for a user of a hearing aid according to the present disclosure. In step S1, the method comprises obtaining a set of in-situ input signals obtained by a hearing aid. The set of in-situ input signals may be one or more in-situ input signals obtained by one or more input transducers constituting the hearing aid. In step S2, the method comprises obtaining a set of in-situ voice signals and a set of in-situ-noise signals based on the set of in-situ input signals. The method may comprise a source separator configured to separate a target speech signal and a noise signal for each of the in-situ input signals in the set of in-situ input signals. The set of in-situ voice signals being the separated target speech signals and the set of in-situ noise signals being the separated noise signals. In step S3, the method comprises obtaining a set of generic noise signals comprising one or more generic noise signals. Each generic noise signal may be provided by a noise generator. In step S4, the method comprises obtaining a set of generic clean speech signals comprising one or more generic clean speech signals. Each generic clean speech signal may be provided by a speech generator. In step S5, the method comprises determining a personalized training data set based on the set of in-situ voice signals, the set of in-situ-noise signals, the set of generic noise signals, and the set of generic clean speech signals. The method may comprise saving the personalized training data in a storage medium such as a digital memory device.

FIG. 2 shows an exemplary block diagram, showing a method that may be used for determining personalized data for a user of a hearing aid according to the present disclosure. The exemplary block diagram shows a user USR (e.g., a hearing aid user) wearing a hearing aid HA. The hearing aid may be positioned behind the ear of the user or in the ear canal of the user. The hearing aid HA is positioned on the left side of the user, but may in other embodiments be positioned on the right side of the user. The hearing aid HA is configured to pick-up sound from a sound environment which the user is located in. The method comprises obtaining a set of in-situ input signals 201 based on the picked-up sound by the hearing aid HA. The method comprises a source separator SEP configured to determine a set of in-situ voice signals 202 and a set of in-situ-noise signals 203 based on the in-situ input signals 201. The method comprises obtaining a set of generic noise signals 205 comprising one or more generic noise signals. Each generic noise signal may be provided by a noise generator GNS. The method comprises obtaining a set of generic clean speech signals 204 comprising one or more generic clean speech signals. Each generic clean speech signal may be provided by a speech generator GSS. The method comprises determining a set of personalized training data PTD based on the set of in-situ voice signals 202, the set of in-situ-noise signals 203, the set of generic noise signals 205, and the set of generic clean speech signals 204. Each of the personalized training data comprises a training pair comprising a training target and a training input. The training target may be either one of the in-situ voice signals 202 or ones of the generic clean speech signals 204 and may be determined based on a corresponding signal-to-noise ratio. The training input may be a combination of the training target and one of the generic noise signal or one of the in-situ-noise signal. The choice of choosing either the generic noise signal or the in-situ-noise signal is based on the corresponding signal-to-noise ratio.

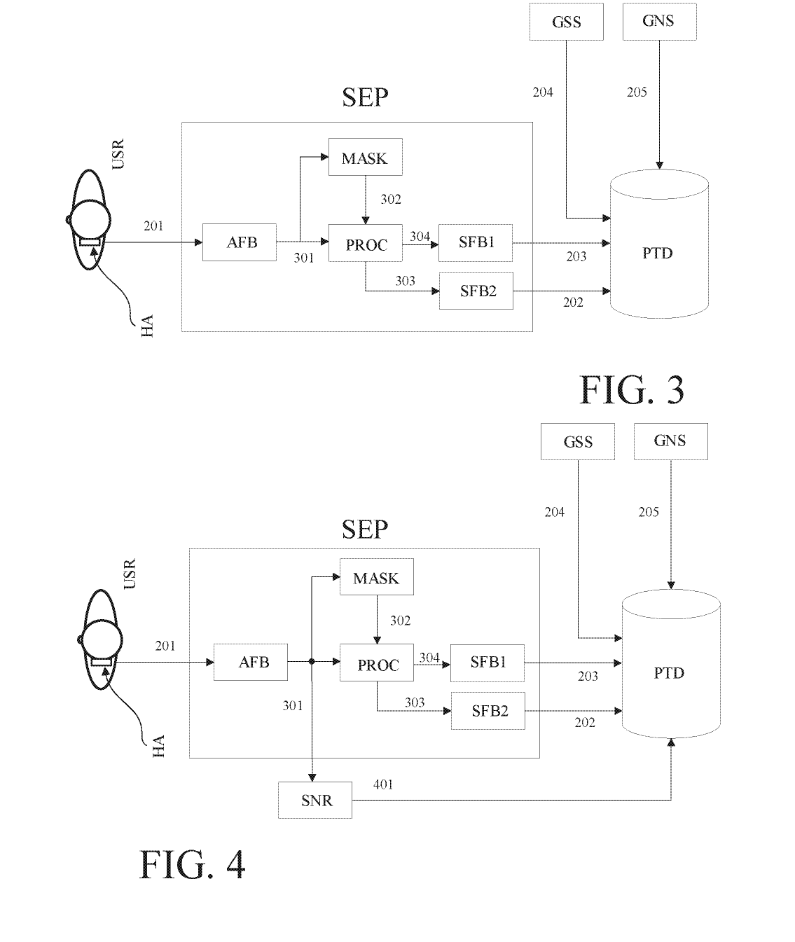

FIG. 3 shows an exemplary block diagram, showing a method that may be used for determining personalized data for a user of a hearing aid, and wherein the in-situ voice signal and the in-situ noise signal are determined based on a source separator according to the present disclosure. The exemplary block diagram shows a user USR (e.g., a hearing aid user) wearing a hearing aid HA. The hearing aid may be positioned behind the ear of the user or in the ear canal of the user. The hearing aid HA is configured to pick-up sound from a sound environment which the user is located in. The method comprises obtaining a set of in-situ input signals 201 based on the picked-up sound by the hearing aid HA. The method comprises a source separator SEP configured to determine a set of in-situ voice signals 202 and a set of in-situ-noise signals 203 based on the in-situ input signals 201. The source separator SEP comprises an analysis filter bank AFB configured to provide a set of time-frequency domain signals 301 based on the set of in-situ input signals 201. Each time-frequency domain signal 301 being indicative of a time-frequency domain representation of one of the in-situ input signals. The source separator SEP may comprise a masking algorithm MASK configured to determine a target mask and a noise mask 302 for each of the time-frequency domain signals constituting the set of time-frequency domain signals. The source separator may comprise a processor PROC configured to provide a set of time-frequency domain in-situ voice signals 303 based on multiplying each of the target masks on the corresponding time-frequency domain signal. The source separator may comprise a processor PROC configured to provide a set of time-frequency domain in-situ noise signals 304 based on multiplying each of the noise masks on the corresponding time-frequency domain signal. The source separator SEP comprises a first synthesis filter bank SFB1 configured to provide the in-situ voice signal 202 by converting the time-frequency domain in-situ voice signal into the time domain. The source separator SEP comprises a second synthesis filter bank SFB2 configured to provide the in-situ noise signal 203 by converting the time-frequency domain in-situ noise signal into the time domain. The method comprises obtaining a set of generic noise signals 205 comprising one or more generic noise signals. Each generic noise signal may be provided by a noise generator. The method comprises obtaining a set of generic clean speech signals 204 comprising one or more generic clean speech signals. Each generic clean speech signal may be provided by a speech generator. The method comprises determining a personalized training data set PTD based on the set of in-situ voice signals 202, the set of in-situ-noise signals 203, the set of generic noise signals 205, and the set of generic clean speech signals 204. Each of the personalized training data comprises a training pair comprising a training target and a training input. The training target may be either one of the in-situ voice signals 202 or one of the generic clean speech signals 204 and may be determined based on a signal-to-noise ratio. The training input may be a combination of the training target and one of the generic noise signal or one of the in-situ-noise signal. The choice of choosing either the generic noise signal or the in-situ-noise signal may be based on the signal-to-noise ratio.

FIG. 4 shows an exemplary block diagram, showing a method that may be used for determining personalized data for a user of a hearing aid, and wherein the in-situ voice signal and the in-situ noise signal are determined based on a source separator according to the present disclosure. The exemplary block diagram shows a user USR (e.g., a hearing aid user) wearing a hearing aid HA. The hearing aid may be positioned behind the ear of the user or in the ear canal of the user. The hearing aid HA is configured to pick-up sound from a sound environment which the user is located in. The method comprises obtaining a set of in-situ input signals 201 based on the picked-up sound by the hearing aid HA. The method comprises a source separator SEP configured to determine a set of in-situ voice signals 202 and a set of in-situ-noise signals 203 based on the in-situ input signals 201. The source separator SEP being configured similarly to the source separator disclosed in the FIG. 3. The method comprises a signal-to-noise ratio estimator SNR configured to estimate a set of signal-to-noise ratios based on the set of time-frequency domain signals 301. The signal-to-noise ratio estimator SNR may be configured to estimate a set of global signal-to-noise ratios 401 each indicative of a global signal-to-noise ratio representing the signal-to-noise ratio across all the frequency bands of a corresponding time-frequency domain signal. The method comprises obtaining a set of generic noise signals 205 comprising one or more generic noise signals. Each generic noise signal may be provided by a noise generator. The method comprises obtaining a set of generic clean speech signals 204 comprising one or more generic clean speech signals. Each generic clean speech signal may be provided by a speech generator. The method comprises determining a personalized training data set PTD based on the set of in-situ voice signals 202, the set of in-situ-noise signals 203, the set of generic noise signals 205, the set of generic clean speech signals 204, and the set of global signal-to-noise ratios SNR 401. Each of the personalized training data comprises a training pair comprising a training target and a training input. Each training target may be either one of the in-situ voice signals 202 or one of the generic clean speech signals 204 and may be determined based on a corresponding global signal-to-noise ratio. The training input may be a combination of the training target and one of the generic noise signals or the corresponding in-situ-noise signal to the global signal-to-noise ratio. The choice of choosing either the generic noise signal or the corresponding in-situ-noise signal is based on the global signal-to-noise ratio.

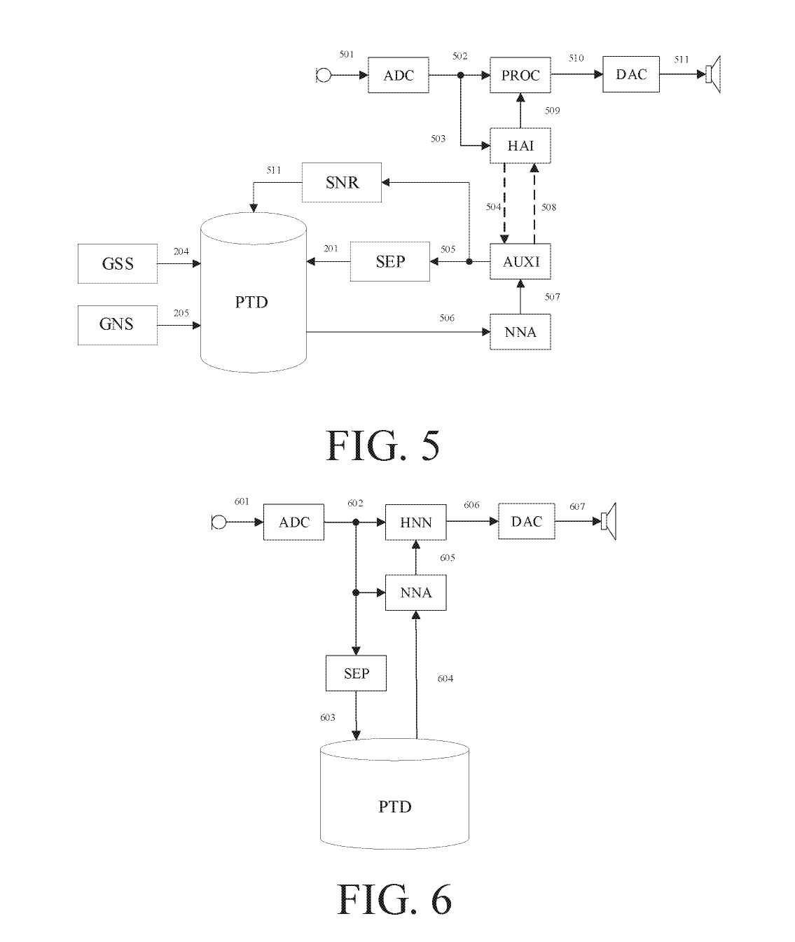

FIG. 5 shows an exemplary block diagram of a hearing aid system comprising a hearing aid an auxiliary device according to the present disclosure. The hearing aid comprises an input transducer such as a microphone configured to pick-up sound of a sound environment and provide an electrical audio input signal 501. The hearing aid comprises an analog-to-digital converter ADC configured to convert the electrical audio input signal 501 into audio input signal 502 being a digitally sampled signal. The hearing aid may comprise a memory unit configured to store one or more audio input signals 502. The stored audio input signals being the set of in-situ input signals. The hearing aid HA comprises a hearing aid interface HAI. The hearing aid interface HAI is configured to wirelessly transmit the set of in-situ input signals. The hearing aid system comprises an auxiliary device comprising an auxiliary device interface AUXI. The auxiliary device interface AUXI is configured to receive the wirelessly transmitted set of in-situ input signals. The auxiliary device comprises a source separator SEP configured to provide a set of in-situ voice signals 201 and a set of in-situ-noise signals 201 based on the set of in-situ input signals. The auxiliary device comprises a signal-to-noise ratio estimator configured to provide a set of global signal-to-noise ratios 511. Each of the global signal-to-noise ratios 511 are determined based on the corresponding wirelessly transmitted in-situ input signal constituting the set of wirelessly transmitted in-situ input signals. The auxiliary device comprises a speech generator GSS configured to provide a set of generic clean speech signal 204. The auxiliary device comprises a noise generator GNS configured to provide a set of generic noise signal 204. The auxiliary device is configured to provide a set of personalized training data each comprising a training pair. Each training pair being determined in dependence of a corresponding global signal-to-noise ratio. The auxiliary device comprises a first threshold and a second threshold. The first threshold is indicative of a lower bound signal-to-noise ratio, and the second threshold is indicative of an upper bound signal-to-noise ratio. If the global signal-to-noise ratio exceeds the second threshold, the training target comprises the corresponding in-situ voice signal to the global signal-to-noise ratio and the training input comprises a combination of the corresponding in-situ voice signal and one of the generic noise signals. If the global signal-to-noise ratio is between the first threshold and the second threshold, the training target comprises the corresponding in-situ voice signal, and the training input comprises a combination of the corresponding in-situ voice signal and the corresponding in-situ-noise signal. If the global signal-to-noise ratio is below the first threshold, the training target comprises one of the generic clean speech signals and the training input comprises a combination of the generic clean speech signal and the corresponding in-situ-noise signal.

The auxiliary device comprises a neural network adaptor provide a personalized neural network parameter 507 based on the set of personalized training data 506. The neural network adaptor comprises an optimization algorithm based on a pre-selected cost function, and a pre-selected neural network architecture. The optimization algorithm is configured to iteratively determine the set of personalized neural network parameters based on the set of personalized training data. The auxiliary device interface AUXI is configured to wirelessly transmit the personalized neural network parameter. The hearing aid interface HAI is configured to provide the personalized neural network parameter based on the transmitted personalized neural network parameter. The hearing aid comprises processor PROC. The processor PROC comprises a hearing aid neural network. The hearing aid neural network comprises an initial neural network comprising initial neural network parameters. When the hearing aid receives the personalized neural network parameter, the processor is configured to modify the initial neural network parameters by substituting one or more of the initial neural network parameters with the personalized neural network parameter, so that the hearing aid neural network comprises an updated neural network. The processor PROC is configured to provide a processed signal 510 based on the one or more audio input signals 502 by using the updated neural network. The hearing aid comprises a digital-to-analog converter DAC configured to convert the processed signal 510 to an analog processed signal 511. The hearing aid comprises a loudspeaker configured to provide an audible processed sound based on the analog processed signal 511.

FIG. 6 shows an exemplary block diagram of a hearing aid according to the present disclosure. The hearing aid comprises an input transducer such as a microphone configured to pick-up sound of a sound environment and provide an electrical audio input signal 601. The hearing aid comprises an analog-to-digital converter ADC configured to convert the electrical audio input signal 601 into audio input signal 602 being a digitally sampled signal. The hearing aid comprises a source separator SEP configured to provide an in-situ voice signal and an in-situ noise signal 603 based on the in-situ input signal 602. The hearing aid may be configured to segment, with a pre-defined time interval, the stream of audio input signals into a plurality of audio input signal segments. The source separator SEP may be configured to provide a set of in-situ voice signals and a set of in-situ-noise signals based on the plurality of audio input signal segments. The hearing aid comprises a personalization training database configured to receive the in-situ voice signal and the in-situ-noise signal 603 and provide personalized training data. The personalization training data being one or more (i.e., a set of) training pairs 604 comprising based on the in-situ voice signal and the in-situ-noise signal. Each training pair comprises a training target based on the in-situ voice signal and a training input based on a combination of the in-situ voice signal and the in-situ-noise signal. The hearing aid comprises a neural network adaptor configured to determine a personalized neural network parameter based the personalized training data. Hearing aid comprises hearing aid processor HNN comprising a hearing aid neural network. The hearing aid processor HNN is configured to update the hearing aid neural network based on the personalized neural network parameter. The hearing aid processor is configured to receive the audio input signal and provide a processed signal based on the updated neural network. The hearing aid comprises a digital-to-analog converter DAC configured to convert the processed signal 606 to an analog processed signal 607. The hearing aid comprises a loudspeaker configured to provide an audible processed sound based on the analog processed signal 607.

The audio input signal or a processed version thereof

It is intended that the structural features of the devices described above, either in the detailed description and/or in the claims, may be combined with steps of the method, when appropriately substituted by a corresponding process.

The term ‘or a processed version thereof’ may e.g. cover such extracted features from an original audio signal. The term ‘or a processed version thereof’ may e.g. also cover an original audio signal that has been subject to a processing algorithm that applies gain or attenuation and/or delay to the original audio signal and this results in a modified audio signal (preferably enhanced in some sense, e.g. noise reduced relative to a target signal, or simply delayed).

As used, the singular forms "a," "an," and "the" are intended to include the plural forms as well (i.e. to have the meaning “at least one”), unless expressly stated otherwise. It will be further understood that the terms "includes," "comprises," "including," and/or "comprising," when used in this specification, specify the presence of stated features, integers, steps, operations, elements, and/or components, but do not preclude the presence or addition of one or more other features, integers, steps, operations, elements, components, and/or groups thereof. It will also be understood that when an element is referred to as being "connected" or "coupled" to another element, it can be directly connected or coupled to the other element, but an intervening element may also be present, unless expressly stated otherwise. Furthermore, "connected" or "coupled" as used herein may include wirelessly connected or coupled. As used herein, the term "and/or" includes any and all combinations of one or more of the associated listed items. The steps of any disclosed method are not limited to the exact order stated herein, unless expressly stated otherwise.

It should be appreciated that reference throughout this specification to "one embodiment" or "an embodiment" or “an aspect” or features included as “may” means that a particular feature, structure or characteristic described in connection with the embodiment is included in at least one embodiment of the disclosure. Furthermore, the particular features, structures or characteristics may be combined as suitable in one or more embodiments of the disclosure. The previous description is provided to enable any person skilled in the art to practice the various aspects described herein. Various modifications to these aspects will be readily apparent to those skilled in the art.

The claims are not intended to be limited to the aspects shown herein but are to be accorded the full scope consistent with the language of the claims, wherein reference to an element in the singular is not intended to mean “one and only one” unless specifically so stated, but rather “one or more.” Unless specifically stated otherwise, the term “some” refers to one or more.

I claim:

1. A method for determining personalized training data for a user of a hearing aid comprising:
obtaining a set of in-situ input signals obtained by the hearing aid,
determining a set of in-situ voice signals and a set of in-situ-noise signals based on the set of in-situ input signals,
obtaining a set of generic noise signals,
obtaining a set of generic clean speech signals,
determining a personalized training data set based on the set of in-situ voice signals, the set of in-situ-noise signals, the set of generic noise signals, and the set of generic clean speech signals.

2. A method according to claim 1, wherein determining the set of in-situ voice signals and the set of in-situ-noise signals based on the set in-situ input signal comprises:
determining a plurality of target speech signals and a plurality of noise signals by providing the set of in-situ input signals to a source separator, and
determining the set of in-situ voice signals based on the plurality of target speech signals, and
determining the set of in-situ-noise signals based on the plurality of noise signals.

3. A method according to claim 1, wherein determining the set of in-situ voice signals and the set of in-situ-noise signals based on the set in-situ input signal comprises:
determining noise dominated regions and speech dominated regions by providing the set of in-situ signals to a voice activity detector,
determining the set of in-situ-noise signals based on the noise dominated regions, and
determining the set of in-situ voice signals based on the voice dominated regions.

4. A method according to claim 1, wherein the set of generic noise signals comprises one or more of the following: signals recorded by a sound engineer, signals recorded by other hearing aids worn by other users, and synthetically generated signals.

5. A method according to claim 1, wherein the set of generic clean speech signals comprises one or more of the following: signals recorded by a sound engineer, signals recorded by other hearing aids worn by other users, and synthetically generated signals.

6. A method according to claim 1, wherein determining the personalized training data set based on the set of in-situ voice signals, the set of in-situ-noise signals, the set of generic noise signals, and the set of generic clean speech signals comprises:
determining a set of training pairs each training pair comprising a training input and a training target, wherein the training target is based on the set of generic clean speech signals or the set of in-situ speech signals, and wherein the training input is based on a combination of the training target and on the set of generic noise signals or the set of in-situ-noise signals.

7. A method according to claim 1, comprising:
determining a personalized neural network parameter based on the personalized training data set,
determining a personalized neural network based on the personalized neural network parameter, and
process an input signal obtained by the hearing aid using the personalized neural network to determine a processed signal.

8. A method according to claim 7, wherein the personalized neural network parameter comprises one or more weights for a neural network.

9. A method according to claim 8, wherein the method comprises,
obtaining a hearing aid parameter associated with the hearing aid, and
determining a personalized neural network parameter based on the personalized training data set and the hearing aid parameter.

10. A method according to claim 1, wherein the method is performed by the hearing aid.

11. A hearing aid system for a self-learning hearing aid comprising:
a hearing aid comprising
one or more input transducers configured to obtain a set of in-situ input signals,
a hearing aid interface for transmitting and receiving signals,
a hearing aid processor comprising a hearing aid neural network, and
an auxiliary device comprising
an auxiliary interface for transmitting and receiving signals,
an auxiliary processor comprises a neural network adaptor, and
wherein the hearing aid interface is configured to transmit the set of in-situ input signals to allow for determining a personalized training data set at an external device,
wherein the neural network adaptor is configured to receive the personalized training data set, and determine a personalized neural network parameter for the hearing aid neural network based on the personalized training data,
wherein the auxiliary interface is configured to transmit the personalized neural network parameter to the hearing aid,
wherein the hearing aid processor is configured to determine an updated hearing aid neural network based on the personalized neural network parameter and the hearing aid neural network, and
wherein the hearing aid neural network is configured to receive an input signal and determine a processed signal based on the updated hearing aid neural network.

12. A hearing aid system according to claim 11, wherein obtaining the in-situ input signal comprises:
obtaining a hearing aid status parameter;
comparing the hearing aid status parameter with a criterion;
if the criterion is fulfilled, transmit the set of in-situ input signals to the external device.

13. A hearing aid system according to claim 12, wherein the hearing aid status parameter comprises one or more of the following: a docking status of the hearing aid, a battery level of the hearing aid, and a wireless link quality to the external device.

14. hearing aid comprising:
one or more input transducers configured to obtain a set of in-situ input signals,
a hearing aid processor the processor being configured to:
determining a set of in-situ voice signals and a set of in-situ-noise signals based on the set of in-situ input signals,
obtaining a set of generic noise signals,
obtaining a set of generic clean speech signals,
determining a personalized training data set based on the set of in-situ voice signals, the set of in-situ-noise signals, the set of generic noise signals, and the set of generic clean speech signals,
determine a personalized neural network parameter for a hearing aid neural network based on the personalized training data,
update the hearing aid neural network based on the personalized neural network parameter, and
wherein the hearing aid processor is configured to receive an input signal and determine a processed signal based on the updated neural network.
